(19) United States
(12) Patent Application Publication
(10) Pub. No.: US 2013/0256398 A1
(43) Pub. Date: Oct. 3, 2013

(54) METHOD AND SYSTEM TO SELECTIVELY PROCESS A CODE

(71) Applicant: Sandra Lynn Godsey, San Jose, CA (US)

(72) Inventor: Sandra Lynn Godsey, San Jose, CA (US)

(73) Assignee: eBay Inc., San Jose, CA (US)

(21) Appl. No.: 13/436,147

(22) Filed: Mar. 30, 2012

(51) Int. Cl. G06F 17/00

(52) U.S. Cl. 235/375

(57) ABSTRACT

A method and system to selectively process a code is provided. An example system includes a scanning component, a settings access module, and a code data processing module. The scanning component may be configured to scan a two-dimensional code, e.g., a QR code to obtain code data. The settings access module may be configured to access user's settings stored on the electronic device. The code data processing module may be configured to apply a processing scheme to at least a portion of the code data, based on the user's settings, process the at least a portion of the code data according to the processing scheme, and perform an action based on a result of the processing.

### TECHNICAL FIELD

This application relates to the technical fields of processing information-embedded codes using electronic hardware devices and, in one example embodiment, a system and method to selectively process a code.

### BACKGROUND

For business activities such as trading goods and inventory management, a device reader accesses the information stored in a code by scanning the code and then using the information, such as to identify a product. A one-dimensional bar code provides a fast and convenient identification method. Quick response code (QR code) is a two-dimensional code. Compared with the conventional one-dimensional barcode, QR code is capable of providing more information capacity since the content is stored in a two-dimensional surface. A QR code is a two-dimensional barcode that offers high-speed and omni-directional reading for an electronic device and which has a large information capacity and high reliability. A multi-dimensional code also is compatible with diverse characters and image information and may be utilized in industrial management, electronic business, personal information exchanges, and many other fields. For example, a user can take a picture of the QR code with a digital camera and thereby retrieve embedded information of the QR code after the picture is identified and decoded by an interpreting module, application or computer-readable software instructions.

### BRIEF DESCRIPTION OF DRAWINGS

Embodiments of the present invention are illustrated by way of example and not limitation in the figures of the accompanying drawings, in which like reference numbers indicate similar elements and in which:

FIG. 1 is a diagrammatic representation of an example network environment, within which an example method and system to selectively process a code may be implemented;

FIG. 2 is a diagrammatic representation of an example device within which an example method and system to selectively process a code may be implemented;

FIG. 3 is block diagram of a system to selectively process a code, in accordance with one example embodiment;

FIG. 4 is a flow chart of a method to selectively process a code, in accordance with an example embodiment; and

FIG. 5 is a flow chart of a method to selectively manipulate a multi-dimensional code, in accordance with an example embodiment; and

FIG. 6 is a diagrammatic representation of an example machine in the form of a computer system within which a set of instructions, for causing the machine to perform any one or more of the methodologies discussed herein, may be executed.

### DETAILED DESCRIPTION

Method and system are provided to selectively process a multi-dimensional code, such as, e.g., a Quick Response (QR) code. A QR code encodes information that may he accessed by an electronic device equipped with an image-recognition component, such as, e.g., a scanner. An electronic device, e.g., a mobile device such as a smart phone, may host a computing application that recognizes the format of a two-dimensional code, processes data encoded in the multi-dimensional code, and performs an action based on the settings stored in the electronic device using the data encoded in the multi-dimensional code. Throughout this description a two-dimensional code, such as a QR code, is used as an example, however, there may be any number of dimensions to a multi-dimensional code, such as a code that has three dimensions or that changes with time or other parameter.

In some embodiments, the settings stored in the electronic device, which may be user's settings or preferences, indicates a processing scheme to be applied to at least a portion of the two-dimensional code. For example, the user's settings may indicate that the data obtained from the two-dimensional code is to be rendered as audio or it may indicate an allergy-consciousness option that may trigger a call to an external database every time a code related to a food item is scanned. The user's settings may also indicate that the user is a preferred customer. A system to selectively process a two-dimensional code may be configured to access the user's settings once a two-dimensional code has been scanned, determine that the user's settings indicate that a certain portion of data encoded in the scanned code is to treated as a promotional code, and access a coupon or discount information associated with the promotional code, and present the coupon or the discount information on the electronic device of the user. While the user's settings that are used for determining a processing scheme with respect to a scanned code may be stored in the electronic device that is suitable for scanning a two-dimensional code, such settings may be stored elsewhere and the system to selectively process a two-dimensional code maybe configured to request access to the remotely-stored user's settings, e.g., in response to detecting a two-dimensional code.

The user's settings associated with the electronic device may also indicate that the data obtained from the two-dimensional code is to be sent to a predetermined destination, e.g., to a certain e-mail address. Other examples of responding to the detecting of a two-dimensional code include presenting a selection of options on the electronic device (e.g., payment options, textual or audio rendering options, an option to obtain additional information related to the data encoded in the detected two-dimensional code, etc.) or, e.g., launching a user interface associated with a preferred payment method such as the secure transfer of funds between member accounts.

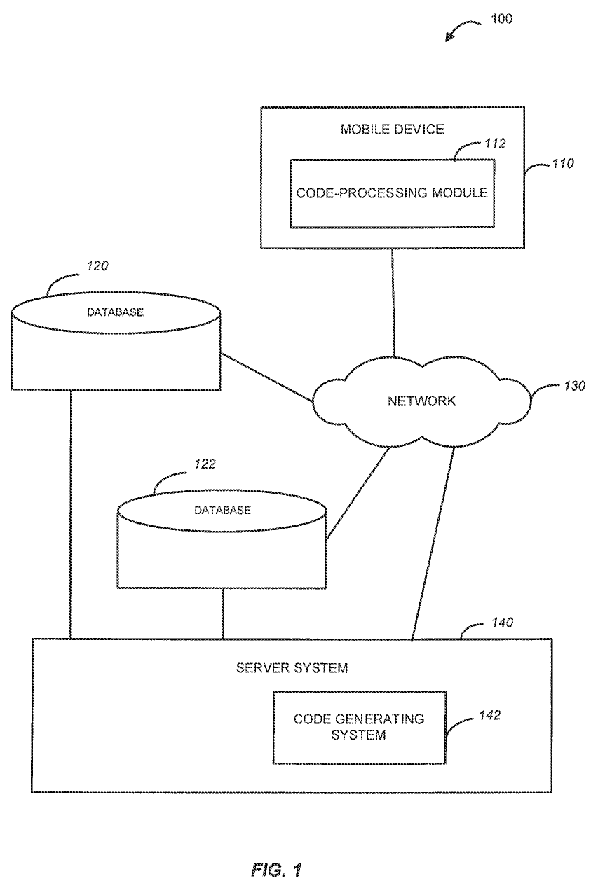

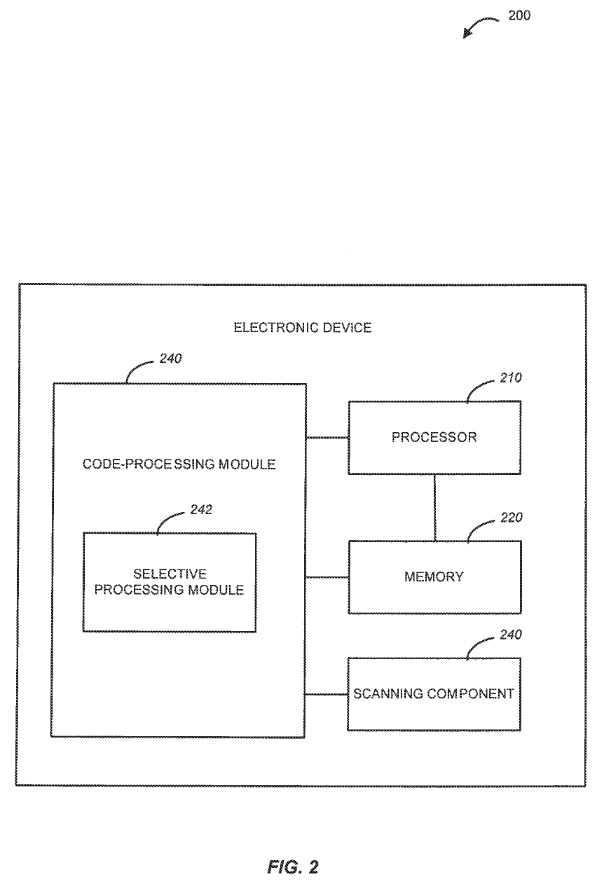

As shown in FIG. 1, the network environment 100 may include a mobile device 110 hosting a code-processing module 112, external databases 120 and 122, and a server system 140. The server system 140, in one example embodiment, may host a code-generating system 142. The code-generating system 142 may be configured to generate and manipulate multi-dimensional codes. The mobile device 110, the server system 140, and the databases 120-122 are shown as interconnected via a communications network 130. The communications network 130 may be a public network (e.g., the Internet, a wireless network, etc.) or a private network (e.g., a local area network (LAN), a wide area network (WAN), Intranet, etc.). The databases 120-122 may reside at disparate locations and may be utilized to store additional information that may be used to supplement or modify data associated with and/or encoded in multi-dimensional codes accessed by the mobile device 110. An example method and system to selectively process a two-dimensional code may be implemented within an electronic device 200 illustrated in FIG. 2.

FIG. 2 shows a diagram of an electronic device 200 that may be used to provide a method and system to selectively process a two-dimensional code, in accordance with example embodiments. The electronic device 200 comprises one or more processors including a processor 210 coupled to a memory 220, a scanning component 240, and a code-processing module 240 configured to process two-dimensional codes. As mentioned above, an example of a two-dimensional code is a QR code. Examples of the electronic device 200 include a mobile phone, a tablet or any other portable or electronic device comprising at least one processor and a memory.

The code-processing module 240 includes a selective processing module 242. The selective processing module 242 may be implemented as a module that is part of the code-processing module 240 or as an add-on that can be utilized with the code-processing module 240. The code-processing module 240 and the selective processing module 242, in one example embodiment, is configured to process two dimensional codes utilizing the stored settings. The stored settings may be, e.g., a user profile maintained by another application or settings obtained for the use of the code-processing module 240. The stored setting may be unique to the user, such as dietary preferences, vision challenges, financial processing preferences, or the stored setting may be a group of settings, such as applied to a group. In one example, users in a group on a social network have a common setting or set of settings that allow group purchasing coupons or promotions. In another example, users in a group on a social network may have a common setting or set of settings that indicate an area of concern, such as environmentally safe products, or allow members of the group to donate funds to their favorite cause through purchases at a given vendor. The stored setting (or a set of settings) provides information which may be accessed by specific users, where in some embodiments the information cannot be accessed by other users. In this way, a single QR code may provide different information to different users. The stored settings determine what information a given user is able to access.

In some embodiments, the information from the QR code initiates a process, wherein the process is determined by the user's settings. Note that in some embodiments the settings may specific to the device and not the user, for example, a specific type of smart phone may have its own specific settings that accesses information that can be used on that type of phone.

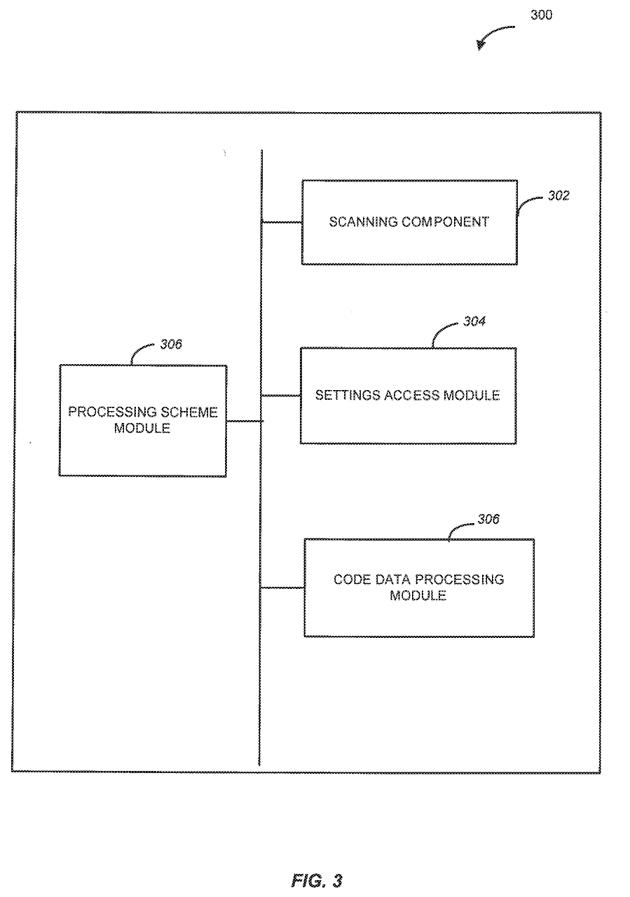

As mentioned above, the stored settings, that may also be referred to as the user's settings, may indicate, for example, a user's preference to use a particular payment method, such as credit card payment or using PayPal®. The stored settings may also indicate a user's preference for audio rendering of the code data. Still further, the stored settings may be indicative of a user's implicit request to query a database if the code data is related to a food item, in order to obtain further details related to the code data. FIG. 3 is a block diagram illustrating a system to selectively process a two-dimensional code, an example of which may be the selective processing module 242 of FIG. 2. This may be used to identify a specific ingredient of interest, such as an allergy-related item, and offer alternative products that do not include that item. In one embodiment, the information identifies a specific product and recommends a wine that would complement that product.

FIG. 3 is a block diagram of a system 300 to selectively process a two-dimensional code, in accordance with one example embodiment. As shown in FIG. 3, the system 300 includes a scanning component 302, a settings access module 304, and a code data processing module 306. The scanning component 302 may be configured to scan a two-dimensional code, e.g., a QR code to obtain code data. The settings access module 304 may be configured to access user's settings stored on the electronic device. The user's settings may be part of a user's profile associated with another computing application or with an on-line trading platform. The code data processing module 306 may be configured to select a processing scheme to at least a portion of the code data, based on the user's settings, process the at least a portion of the code data according to the selected processing scheme, and perform an action based on a result of the processing. Note that a hardware switch may be implemented on the electronic device to select a processing mode. In one example, a switch may select an audio mode, wherein the QR code includes instructions to provide audio mode for the visually impaired so that specific information is read to the user. A dynamic QR code may be displayed at a traffic light or intersection to enable the visually impaired to receive an audio message or signal indicating it is safe to cross an intersection. A dynamic QR code is generated by a device having display capabilities, such as on the display of a smart phone, computer monitor or other display. In another embodiment, the dynamic QR code may be modified by a control from the electronic device, wherein the user initiates transmission of a signal to the device displaying the dynamic QR code. The signal instructs the display device to change the QR code to reflect information provided by the user.

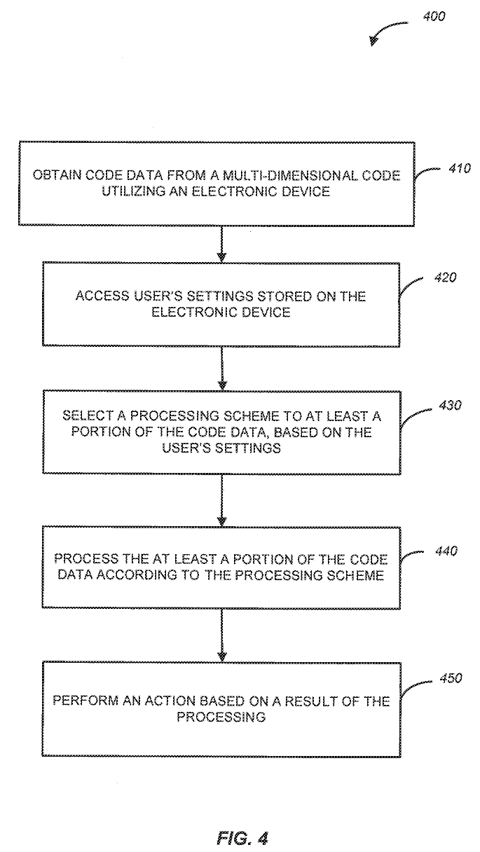

FIG. 4 is a flow chart of a method 400 to selectively process a two-dimensional code, according to one example embodiment. The method 400 may be performed by processing logic that may comprise hardware (e.g., dedicated logic, programmable logic, microcode, etc.), software (such as run on a general purpose computer system or a dedicated machine), or a combination of both. In one example embodiment, the processing logic resides at the electronic device shown in FIG. 2 and, specifically, at the system 300 shown in FIG. 3.

As shown in FIG. 4, the method 400 commences at operation 410, when the scanning component 302 of FIG. 3 scans a multi-dimensional code, e.g., a QR code to obtain code data, The settings access module 304 of FIG. 3 accesses user's settings stored on the electronic device at operation 420. The user's settings may be part of a user's profile associated with another computing application or with an on-line trading platform. The code data processing module 306 of FIG. 3 selects, at operation 430, a processing scheme to be applied to at least a portion of the code data, based on the user's settings. The code data processing module 306 then processes, at operation 440, at least a portion of the code data according to the selected processing scheme and performs an action based on a result of the processing (operation 450).

In one embodiment, the processing scheme comprises omitting processing of a portion of the code data. For example, if the user's settings do not have an indication that the user is a preferred user or customer, a portion of the code data representing a promotional code or a link to a discount coupon is not processed and the user is not presented with a discount information that may be associated with the two-dimensional code. An action that the code data processing module 206 may perform based on the result of the processing of the code data may include presenting one or more selectable options on the electronic device. The options may include rendering the code data as audio, one of several payment methods, transmitting the coded data to an email address, etc.

An example of a processing scheme includes presenting a user interface associated with a payment option indicated by the user's settings. For instance, in the user's settings indicate a preference for PayPal® payment option, the code data processing module 306 may present PayPal® user interface in response to scanning the two-dimensional code. Another example of a processing scheme comprises accessing a database to retrieve additional information related to the code data.

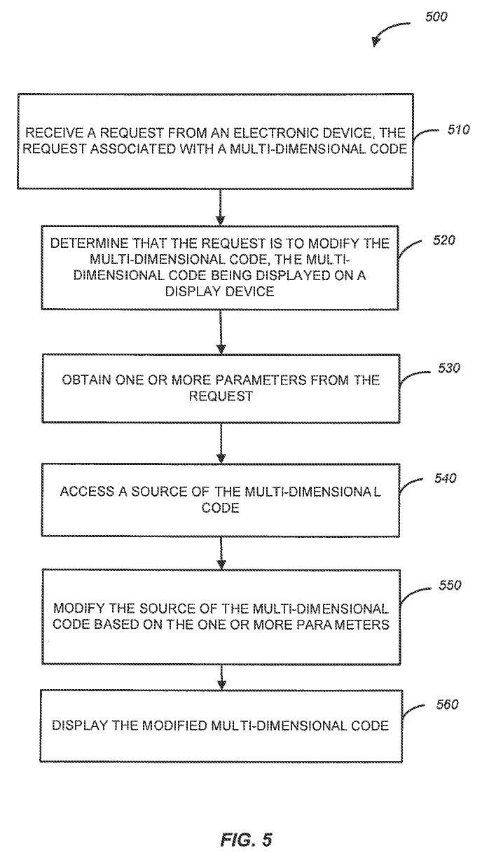

FIG. 5 is a flow chart of a method 500 to selectively manipulate a multi-dimensional code, according to one example embodiment. The method 400 may be performed by processing logic that may comprise hardware (e.g., dedicated logic, programmable logic, microcode, etc.), software (such as run on a general purpose computer system or a dedicated machine), or a combination of both. In one example embodiment, the processing logic resides at the mobile device 110 and at the server system 140 shown in FIG. 1.

As shown in FIG. 5, the method 500 commences at operation 510, when a computer system, e.g., a server system, receives a request associated with a multi-dimensional code. At operation 520, the computer system determined that the request is to modify the multi-dimensional code that is being displayed on a display device. The computer system obtains, from the request, one or more parameters (operation 530), accesses a source of the multi-dimensional code (operation 540), and modifies the source of the multi-dimensional code based on the one or more parameters (operation 550). At operation 560, the modified multi-dimensional code is displayed on a display device.

As mentioned above, this method may be utilized with respect to dynamic QR codes, where a dynamic QR code is displayed by a device having display capabilities, such as on the display of a smart phone, computer monitor or other display device. Modification of such dynamic QR code may be initiated by a control from an electronic device, wherein the user initiates transmission of a signal to the device displaying the dynamic QR code. The signal instructs the display device to change the QR code to reflect information provided by the user.

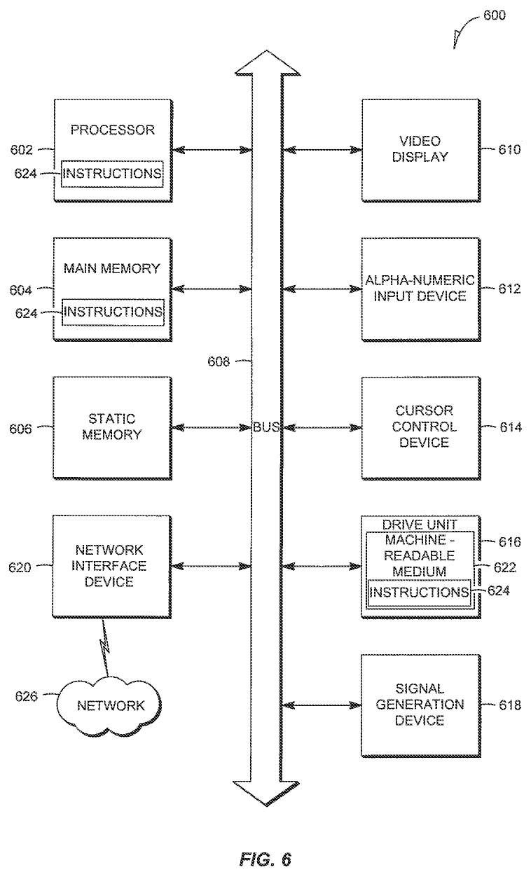

FIG. 6 shows a diagrammatic representation of a machine in the example form of a computer system 600 within which a set of instructions, for causing the machine to perform any one or more of the methodologies discussed herein, may be executed. In alternative embodiments, the machine operates as a stand-alone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 600 includes a processor 602 (e.g., central processing unit (CPU), a graphics processing unit (GPU) or both), a main memory 604 and a static memory 606, which communicate with each other via a bus 606, The computer system 600 may further include a video display unit 610 (e.g., a liquid crystal display (LCD) or a cathode ray tube (CRT)). The computer system 600 also includes an alpha-numeric input device 612 (e.g., a keyboard), a user interface (UI) navigation device 614 (e.g., a cursor control device), a disk drive unit 616, a signal generation device 618 (e.g., a speaker) and a network interface device 620.

The disk drive unit 616 includes a machine-readable medium 622 on which is stored one or more sets of instructions and data structures (e.g., software 624) embodying or utilized by any one or more of the methodologies or functions described herein. The software 624 may also reside, completely or at least partially, within the main memory 604 and/or within the processor 602 during execution thereof by the computer system 600, with the main memory 604 and the processor 602 also constituting machine-readable media.

The software 624 may further be transmitted or received over a network 626 via the network interface device 620 utilizing any one of a number of well-known transfer protocols (e.g., Hyper Text Transfer Protocol (HTTP)).

While the machine-readable medium 622 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing and encoding a set of instructions for execution by the machine and that cause the machine to perform any one or more of the methodologies of embodiments of the present invention, or that is capable of storing and encoding data structures utilized by or associated with such a set of instructions. The term “machine-readable medium” shall accordingly be taken to include, but not be limited to, solid-state memories, optical and magnetic media. Such media may also include, without limitation, hard disks, floppy disks, flash memory cards, digital video disks, random access memory (RAMs), read only memory (ROMs), and the like.

The embodiments described herein may be implemented in an operating environment comprising software installed on a computer, in hardware, or in a combination of software and hardware. Such embodiments of the inventive subject matter may be referred to herein, individually or collectively, by the term “invention” merely for convenience and without intending to voluntarily limit the scope of this application to any single invention or inventive concept if more than one is, in fact, disclosed.

Thus, a method and system to selectively process a two-dimensional code has been described. Although embodiments have been described with reference to specific example embodiments, it will be evident that various modifications and changes may be made to these embodiments without departing from the broader spirit and scope of the inventive subject matter. Accordingly, the specification and drawings are to be regarded in an illustrative rather than a restrictive sense.

1. A method comprising:
scanning a multi-dimensional code utilizing an electronic device to obtain code data;
accessing user's settings stored on the electronic device;
based on the user's settings, selecting a processing scheme for processing at least a portion of the code data;
processing, using at least one processor coupled to a memory, the at least a portion of the code data according to the processing scheme; and
performing an action based on a result of the processing.

2. The method of claim 1, wherein the processing scheme comprises omitting processing of a portion of the code data.

3. The method of claim 1, wherein the action comprises presenting one or more selectable options on the electronic device.

4. The method of claim 3, wherein an option from the one or more selectable options comprises rendering the code data as audio.

5. The method of claim 3, wherein an option from the one or more selectable options comprises a payment method selection.

6. The method of claim 3, wherein an option from the one or more selectable options comprises transmitting the coded data to an email address.

7. The method of claim 1, wherein the processing scheme comprises presenting a user interface associated with a payment option indicated by the user's settings.

8. The method of claim 1, wherein the processing scheme comprises accessing a database to retrieve additional information related to the code data.

9. The method of claim 1, wherein the electronic device is a mobile phone.

10. The method of claim 1, wherein the two dimensional code is a Quick Response (QR) code.

11. A computer-implemented system comprising:
at least one processor coupled to a memory;
a scanning component to scan a two-dimensional code utilizing an electronic device to obtain code data;
a settings access module to access user's settings stored on the electronic device; and
a code data processing module to:
select a processing scheme for processing at least a portion of the code data, based on the user's settings,
process the at least a portion of the code data according to the processing scheme, and
perform an action based on a result of the processing.

12. The system of claim 11, Wherein the processing scheme comprises omitting processing of a portion of the code data.

13. The system of claim 11, wherein the code data processing module is to present one or more selectable options on the electronic device.

14. The system of claim 13, wherein an option from the one or more selectable options comprises rendering the code data as audio.

15. The system of claim 13, wherein an option from the one or more selectable options comprises a payment method selection.

16. The system of claim 13, wherein the code data processing module is to transmit the coded data to an email address.

17. The system of claim 11, wherein the electronic device is a mobile phone.

18. The system of claim 11, wherein the code data processing module is to present a user interface associated with a payment option indicated by the user's settings.

19. The system of claim 11, wherein the two dimensional code is a Quick Response (QR) code.

20. A machine-readable non-transitory storage medium having instruction data to cause a machine to:
scan a multi-dimensional code utilizing an electronic device to obtain code data;
access user's settings stored on the electronic device;
select a processing scheme for processing at least a portion of the code data, based on the user's settings;
process the at least a portion of the code data according to the processing scheme; and
perform an action based on a result of the processing.
